(19) United States
(12) Patent Application Publication
(10) Pub. No.: US 2001/0045926 A1
(43) Pub. Date: Nov. 29, 2001

(54) Liquid crystal display device

(75) Inventors: Yoshio Oowaki, Mobara (JP); Yoichi Igarashi, Mobara (JP)

Correspondence Address: Stanley P. Fisher, Reed Smith Hazel & Thomas LLP, 3110 Fairview Park Drive, Suite 1400, Falls Church, VA, 22042-4503, US

(73) Assignee: Hitachi, Ltd.

(21) Appl. No.: 09/839,163

(22) Filed: Apr. 23, 2001

(30) Foreign Application Priority Data
Apr. 28, 2000 (JP) 2000-130649

(51) Int. Cl. G09G 3/36

(52) U.S. Cl. 345/87

(57) ABSTRACT

In a liquid crystal display device comprising a liquid crystal display element, a plurality of driving circuits being provided for the liquid crystal display element at least one of which has at least one output terminal being not connected to any signal lines of the liquid crystal element, and a display control device transmitting display data including that corresponding to the at least one output terminal (i.e. an ineffective display datum) to the plurality of driving circuits, the present invention transmits another datum being transmitted either prior to or subsequently to the ineffective display datum which corresponds to another output line being connected to one of signal lines of the liquid crystal element to the at least one of the plurality of driving circuits instead of the ineffective display datum and reduces transmission frequency of a bus line of the liquid crystal display device.

### BACKGROUND OF THE INVENTION

1. Field of the Invention

The present invention relates to a liquid crystal display device and, more particularly, to an art useful for application to a driving circuit (drain driver).

2. Description of the Related Art

Liquid crystal display modules of a STN (Super Twisted Nematic) type or aTFT (Thin Film Transistor) type of are widely used as display devices for notebook type personal computers or the like.

A liquid crystal display device of this sort comprises a liquid crystal display panel, driving circuits (drain drivers and gate drivers) for driving the liquid crystal display panel, a display control device (or a timing controller) and a power source circuit.

Such a liquid crystal display device is described in, for example, Japanese Patent Application Laid Open No. 268838/1998 (a specification of Japanese Application No. 71328/1997).

### SUMMARY OF THE INVENTION

According to the demand for increasing the screen sizes of liquid crystal display panels for liquid crystal display devices in recent years, the liquid crystal display panel has been required to have a far higher resolution such as 1024×768 pixels in XGA display mode, 1280×1024 pixels in SXGA display mode or 1600×1200 pixels in UXGA display mode.

To cope with this further increase in the resolution of the liquid crystal display panel, there is a liquid crystal display device in which a display control device supplies the first display data acquiring clock signals to odd-numbered drain drivers and supplies the second display data acquiring clock signals to even-numbered drain drivers, and the display control device alternately transmits display data for the even-numbered drain drivers and display data for the odd-numbered drain drivers, thereby reducing the frequencies of the display data acquiring clock signals to be supplied to the drain drivers from the display control device.

For reducing manufacturing costs of such liquid crystal display devices described above, multi-purpose type drivers are often utilized as the drain drivers thereof.

In the liquid crystal display device of this sort, the number of the drain signal lines of a liquid crystal display panel thereof is occasionally smaller than the number of output terminals of all the drain drivers provided therein. In such a case, the drain drivers have been used while excess output terminals thereof have been left unconnected to any drain signal lines of the liquid crystal display panel, hitherto.

However, because of the circuit construction of the drain driver, the drain driver having such excess output terminals needs to be supplied with display data for all of output terminals thereof.

In the following description, display data for the excess output terminals are referred to as ineffective display data, and display data for output terminals other than the excess output terminals are referred to as effective display data, hereinafter.

In the prior art, a high level (referred to simply as H level, hereinafter) or a low level (referred to simply as L level, hereinafter) is outputted as the ineffective display data.

However, in this prior art method, there have been some case where as an arrangement of data on the bus line on which the display data is transmitted, there occur, for instance, a repetition of an H-level ineffective display datum→an L-level effective display datum→an H-level ineffective display datum, or a repetition of an L-level ineffective display datum→an H-level effective display datum→an L-level ineffective display datum, so that the transmission frequency on the bus line increases.

On the other hand, in the field of information equipment such as personal computers, restrictions are imposed on the amount of radiant electromagnetic noise allowed to be generated from the information equipment.

For reducing the amount of generation of radiant electromagnetic noise from the liquid crystal display device as much as possible, reduction of the transmission frequency on the bus line thereof is an effective method, but in the liquid crystal display device of the prior art described above has the problem that the transmission frequency on the bus line increases during transmission of display data containing ineffective display data.

The invention has been made to solve the above-described problems of the prior art, and provides an art which can reduce the transmission frequency on the bus line of a liquid crystal display device while display data containing ineffective display data are being transmitted from a display control device to a driving circuit in the liquid crystal display device.

The invention further provides an art which enables a display control device to be used in common in liquid crystal display devices, thereby reducing the costs thereof.

The above and other aspects and novel features of the invention become apparent from the following description, taken in conjunction with the accompanying drawings.

Representative aspects of the invention disclosed in the present application will be described below in brief.

One of examples of liquid crystal display devices according to the present invention comprises: a liquid crystal display element (called a liquid crystal display panel, also); a plurality of driving circuits (driving the liquid crystal display element); and a display control device transmitting display data including an ineffective datum to the plurality of driving circuits, and the display control device transmits an effective display datum (or, a datum having a same level as that of a display datum) being transmitted prior to the ineffective display datum thereby instead of the ineffective display datum during a period when the ineffective display datum should be transmitted thereby. For instance, if the display data are distributed to the plurality of driving circuits per a clock pulse or a signal waveform like that by the display control device, the display control device does not send one of the display data corresponding to during a certain clock pulse to one of the plurality of driving circuits to which the one of the display data should be inputted by recognizing the one of the display data as invalid, but sends another of the display data corresponding to one clock pulse before the certain clock pulse and being sent to another of the plurality of driving circuits to the one of the plurality of driving circuits instead of the one of the display data.

On the other hand, the other one of examples of the liquid crystal display devices according to the present invention comprises: a liquid crystal display element; a plurality of driving circuits; and a display control device transmitting display data including an ineffective datum to the plurality of driving circuits, and the display control device transmits an effective display datum (or, a datum having a same level as that of a display datum) being transmitted subsequently to the ineffective display datum thereby instead of the ineffective display datum during a period when the ineffective display datum should be transmitted thereby. For instance, if the display data are distributed to the plurality of driving circuits per a clock pulse or a signal waveform like that by the display control device, the display control device does not send one of the display data corresponding to during a certain clock pulse to one of the plurality of driving circuits to which the one of the display data should be inputted by recognizing the one of the display data as invalid, but sends another of the display data corresponding to one clock pulse after the certain clock pulse and being sent to another of the plurality of driving circuits to the one of the plurality of driving circuits instead of the one of the display data.

The aforementioned certain clock pulse is distinguished from the one clock pulse before or after the certain clock pulse, for instance, in accordance with a difference between a high-level and a low-level of a waveform of the clock signal.

Moreover, the other one of examples of the liquid crystal display devices according to the present invention comprises: a liquid crystal display element; a plurality of driving circuits (for instance, being composed of odd-numbered thereof and even-numbered thereof being lined up alternately with each other along a side of the liquid crystal display panel); and a display control device transmitting display data for odd numbered ones of the plurality of driving circuits and display data for even numbered ones thereof (other than those for the odd numbered ones thereof) thereto, and the display control device transmits an effective display datum (or, a datum having a same level as that of a display datum) for the odd numbered thereof being transmitted prior to an ineffective display datum to be inputted to an at least one of the even numbered ones thereof instead of the ineffective display datum during a period when the ineffective display datum should be transmitted to the at least one of the even numbered ones thereof.

On the other hand, the other one of examples of the liquid crystal display devices according to the present invention comprises: a liquid crystal display element; a plurality of driving circuits (for instance, being composed of odd-numbered thereof and even-numbered thereof being lined up alternately with each other along a side of the liquid crystal display panel); and a display control device transmitting display data for odd numbered ones of the plurality of driving circuits and display data for even numbered ones thereof (other than those for the odd numbered ones thereof) thereto, and the display control device transmits an effective display datum (or, a datum having a same level as that of a display datum) for the even numbered thereof being transmitted subsequently to an ineffective display datum to be inputted to an at least one of the odd numbered ones thereof instead of the ineffective display datum during a period when the ineffective display datum should be transmitted to the at least one of the odd numbered ones thereof.

Furthermore, the other one of examples of the liquid crystal display devices according to the present invention comprises: a liquid crystal display element; a plurality of driving circuits; and a display control device transmitting display data for odd numbered ones of the plurality of driving circuits and display data for even numbered ones thereof (other than those for the odd numbered ones thereof) thereto alternately, and the display control device has a first storing means for storing display data for the odd numbered ones of the plurality of driving circuits which are inputted from an outside of (e.g. an external circuit to) the liquid crystal display device and a second storing means for storing display data for the even numbered ones of the plurality of driving circuits which are inputted from an outside of (e.g. an external circuit to) the liquid crystal display device, reads out the display data from the first storing means and the second storing means alternately and transmits them to the plurality of driving circuits (e.g. successively), and transmits an effective display datum (or, a datum having a same level as that of a display datum) for the odd numbered thereof being transmitted prior to an ineffective display datum to be inputted to an at least one of the even numbered ones thereof instead of the ineffective display datum during a period when the ineffective display datum should be transmitted to the at least one of the even numbered ones thereof.

In an embodiment of the present invention, the display control device detects timing for transmitting an ineffective (invalid) display datum and transmits an effective (valid) display datum read out from the first storing means as the ineffective display datum.

In the embodiment of the present invention, the display control device stores an effective display datum for the odd numbered driving circuit being situated (sited) before an ineffective datum in the second storing means (e.g. along a time axis), if a display datum to be stored in the second storing means is ineffective (invalid).

Furthermore, on the other hand, the other one of examples liquid crystal display devices according to the present invention comprises: a liquid crystal display element; a plurality of driving circuits; and a display control device transmitting display data for odd numbered ones of the plurality of driving circuits and display data for even numbered ones thereof (other than those for the odd numbered ones thereof) thereto alternately, and the display control device has a first storing means for storing display data for the odd numbered ones of the plurality of driving circuits which are inputted from an outside of (e.g. an external circuit to) the liquid crystal display device and a second storing means for storing display data for the even numbered ones of the plurality of driving circuits which are inputted from an/the outside of (e.g. an/the external circuit to) the liquid crystal display device, reads out the display data from the first storing means and the second storing means alternately and transmits them to the plurality of driving circuits (e.g. successively), and transmits an effective display datum (or, a datum having a same level as that of a display datum) for the even numbered thereof being transmitted subsequently to an ineffective display datum to be inputted to an at least one of the odd numbered ones thereof instead of the ineffective display datum during a period when the ineffective display datum should be transmitted to the at least one of the odd numbered ones thereof.

In an embodiment of the present invention, the display control device detects timing for transmitting an ineffective (invalid) display datum and transmits an effective (valid) display datum read out from the second storing means as the ineffective display datum.

In the embodiment of the present invention, the display control device stores an effective display datum for the even numbered driving circuit following an ineffective datum in the first storing means, if a display datum to be stored in the first storing means is ineffective (invalid).

In the embodiments of the present invention, the display control device detects transmission timing of the ineffective datum by counting clock signals being transmitted (dispatched) to the plurality of the driving circuits.

In the embodiments of the present invention, at least one of the plurality of driving circuits has at least one output terminal being not connected to any signal lines of the liquid crystal display element, and the ineffective display datum is inputted to an internal circuit of the at least one of the plurality of driving circuits corresponding to the at least one output terminal thereof.

Moreover, one of the liquid crystal display devices according to the present invention comprises a liquid crystal display element and a display control device controlling the liquid crystal display element, and the display control device changes (or, alters) an signal input mode thereof in accordance with a number of the display data in a display timing signals inputted thereto from an outside thereof.

Additionally in the embodiment of the present invention, the display control device has counting means which counts external clock number in the display timing signal, discrimination means which discriminates an operation mode thereof in accordance with the count number counted by the counting means, and mode switching means for changing (switching) signal input mode thereof internally in accordance with discrimination result of the discrimination means.

According to the aforementioned means, since a level of the display data is kept away from being altered (changed) during displaying data transmission including ineffective datum from the display control device to each of the driving circuits, transmission frequency on a bus line can be reduced.

Additionally, by the aforementioned means, since the display control device changes operation mode thereof in accordance with the number of display data in the display timing signal being inputted therein from the outside thereof, the display control device is utilized commonly regardless of the respective operation modes thereof so that the cost of the liquid crystal display device can be reduced.

These and other objects, features and advantages of the present invention will become more apparent from the following description when taken in conjunction with the accompanying drawings.

### BRIEF DESCRIPTION OF THE DRAWINGS

FIG. 1 is a block diagram showing a schematic construction of a TFT type of liquid crystal display module according to Embodiment 1 of the invention;

FIG. 2 is a view showing the equivalent circuit of one example of the liquid crystal display panel 10 shown in FIG. 1;

FIG. 3 is a view showing the equivalent circuit of another example of the liquid crystal display panel 10 shown in FIG. 1;

FIG. 4 is a block diagram showing the schematic construction of one example of the drain drivers 130 shown in FIG. 1;

FIG. 5 is a block diagram for explaining the construction of the drain driver 130 shown in FIG. 4, as well as the construction of an output circuit 157 thereof;

FIG. 6A is a block diagram showing transmission paths of display data from the display control device 110 to the liquid crystal display panel 10 shown in FIG. 1, FIG. 6B is an eye-diagram explaining the arrangement of the display data outputted from the display control device, and FIG. 6C is waveform diagrams explaining the phase relationship between the clock signals CL2A and CL2B;

FIG. 7 is a view showing the construction of a display data transmission part in the display control device shown in FIG. 1;

FIG. 8A is a block diagram showing the circuit construction of the selector generator part 22 shown in FIG. 7, and FIG. 8B is a diagram showing waveforms of input signals to the selector generator part 22 and output signals therefrom;

FIGS. 9A and 9B are a block diagram showing a circuit construction of the selector generator part 22 in which the counter CK decoder part is omitted from the circuit construction shown in FIGS. 8A, and FIG. 9B is a diagram showing waveforms of input signals to the selector generator part 22 of FIG. 9A and output signals therefrom;

FIG. 10 is a block diagram showing an example of the transmission paths of display data from the display control device 110 to the liquid crystal display panel 10 in a TFT type liquid crystal display module in which a drain driver 130 having unconnected output terminals is mounted;

FIG. 11 is a block diagram showing another circuit construction of the selector generator 22 shown in FIG. 7;

FIG. 12A is a block diagram showing transmission paths of display data from the display control device 110 to the liquid crystal display panel 10 shown in FIG. 1 in a TFT type of liquid crystal display module in which the number of odd-numbered drain drivers DRV1, DRV3, DRV5 thereof differs from the number of even-numbered drain drivers DRV2, DRV4 thereof, FIG. 12B is an eye-diagram explaining the arrangement of the display data outputted from the display control device 110 in FIG. 12A, and FIG. 12C is waveform diagrams explaining the phase relationship between the clock signals CL2A and CL2B;

FIG. 13 is a block diagram showing another example of the transmission paths of display data from the display control device 110 to the liquid crystal display panel 10 in the TFT type liquid crystal display module in which a drain driver 130 having unconnected output terminals is mounted;

FIG. 14 is a block diagram showing another circuit construction of the selector generator part 22 shown in FIG. 7;

FIG. 15 is a view showing the arrangement of the pins of a display control device LSI according to Embodiment 2 of the invention (the term “pins” used herein indicates individual signal (voltage) input/output terminals provided on the package of an integrated circuit (IC) such as a very large scale integrated circuit);

FIG. 16 is a view for explaining the manner of arrangement of a mode pin PIX in the case where each input terminal of the display control device 110 is directly connected to an interface connector CT;

FIG. 17 is a block diagram showing the construction of the essential portions of the TFT type of liquid crystal display module in which an LVDS method is adopted as its digital interface;

FIG. 18 is a view for explaining a method of setting the mode pin PIX in the case where display data and the like are inputted to the display control device from the outside by the LVDS method;

FIGS. 19A and 19B are views showing the timing chart of control signals inputted from the outside, FIG. 19A shows respective signal waveforms of the Interface for Single Pixel Lines, FIG. 19B shows those of the Interface for Dual Pixel Lines; and

FIG. 20 is a view showing one example of a circuit construction for determining whether its input mode is based on one-pixel input operations or two-pixel input operations in the display control device 110.

### DETAILED DESCRIPTION

Embodiments of the invention will be described below in detail with reference to the accompanying drawings.

Incidentally, in all the drawings for explaining the embodiments, constituent elements having the same functions are denoted by the same reference numerals, and a repetitive description of the same constituent elements is omitted herein.

### Embodiment 1

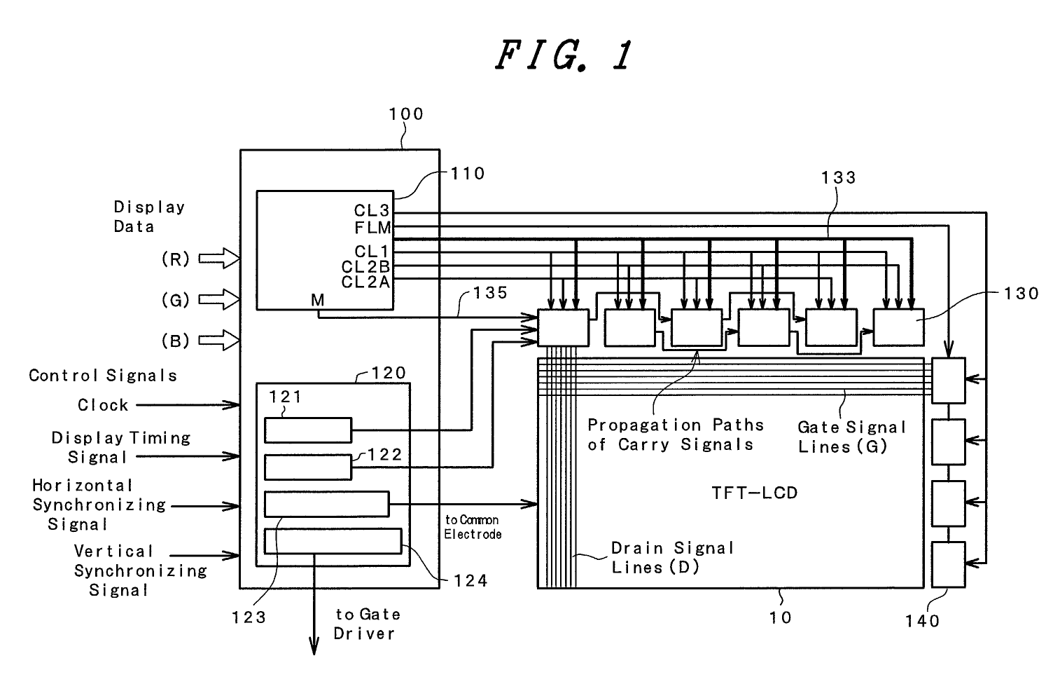

FIG. 1 is a block diagram showing a schematic construction of a TFT type of liquid crystal display module according to Embodiment 1 of the invention.

The liquid crystal display module according to Embodiment 1 includes drain drivers 130 disposed on one longer side of a liquid crystal display panel (TFT-LCD) 10, and gate drivers 140 disposed on one shorter side of the liquid crystal display panel 10.

An interface part 100 is mounted on an interface board, and the drain drivers 130 and the gate drivers 140 are respectively mounted on dedicated printed circuit boards.

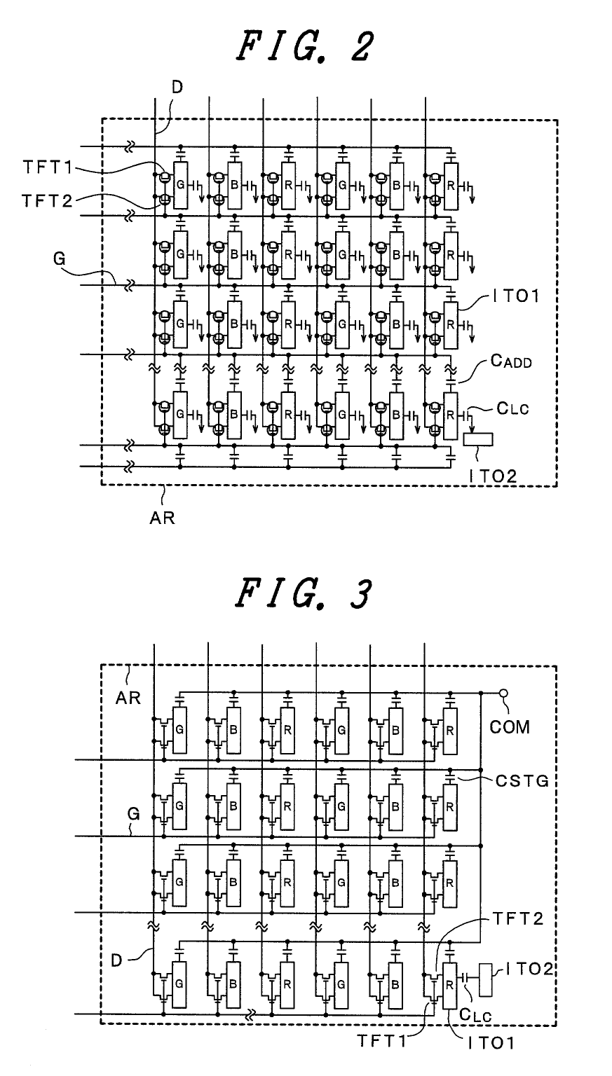

FIG. 2 is a view showing the equivalent circuit of one example of the liquid crystal display panel 10 shown in FIG. 1.

As shown in FIG. 2, the liquid crystal display panel 10 has a plurality of pixels formed in matrix form.

Each of the pixels is disposed in the area of intersection of two adjacent signal lines (drain signal lines D or gate signal lines G) and two adjacent signal lines (gate signal lines G or drain signal lines D).

Each of the pixels has thin film transistors TFT1 and TFT2, and the source electrodes of the thin film transistors TFT1 and TFT2 of each of the pixels are connected to a pixel electrode ITO1. Since a liquid crystal layer is provided between the pixel electrode ITO1 and a common electrode ITO2, a liquid crystal capacitance CLC is equivalently connected between the pixel electrodes TFT1 and TFT2 and the common electrode ITO2.

An added capacitance CADD is connected between the source electrodes of the thin-film transistors TFT1 and TFT2 and the front-stage one of the two adjacent gate signal lines G.

FIG. 3 is a view showing the equivalent circuit of another example of the liquid crystal display panel 10 shown in FIG. 1.

In the example shown in FIG. 2, the added capacitance CADD is formed between the front-stage gate signal line G and the source electrodes, but in the equivalent circuit of the example shown in FIG. 3, unlike the example shown in FIG. 2, a storage capacitance CSTG is formed between the source electrodes of the thin film transistors TFT1 and TFT2 of each of the pixels and a common signal line COM to which to apply a voltage VCOM to be supplied to the common electrode ITO2.

Incidentally, in each of FIGS. 2 and 3, symbol AR denotes a display area.

The invention can be applied to either of the examples. In the former example, pulses on the front-stage gate signal line G may penetrate into the pixel electrode ITO1 through the added capacitance CADD, but in the latter example, since such penetration does not occur, a far better display is enabled. The term “penetration of pulses” used herein means that a charge which corresponds to a certain signal exerts an influence on a portion (such as an electrode) to which to input this signal.

Each of FIGS. 2 and 3 also shows the equivalent circuit of a vertical electric field type of liquid crystal display panel, and furthermore, each of FIGS. 2 and 3 is a circuit diagram which is drawn to correspond to an actual geometric arrangement.

In each of the liquid crystal display panels 10 shown in FIGS. 2 and 3, the drain electrode of each of the thin film transistors TFT1 and TFT2 of each of the pixels which are disposed in the column direction is connected to the adjacent one of the drain signal lines D, and each of the drain signal lines D is connected to the corresponding one of the drain drivers 130 for supplying gray scale voltages to the liquid crystals of the corresponding ones of the pixels disposed in the column direction.

The gate electrodes of the thin film transistors TFT1 and TFT2 of each of the pixels which are disposed in the row direction are connected to the adjacent one of the gate signal lines G, and each of the gate signal lines G is connected to the corresponding one of the gate drivers 140 which supply, during one horizontal scanning period, scanning driving voltages (positive bias voltages or negative bias voltages) to the gate electrodes of the thin film transistors TFT1 and TFT2 of the corresponding ones of the pixels disposed in the row direction.

The interface block 100 shown in FIG. 1 is made of a display control device 110 and a power source circuit 120.

The display control device 110 is made of one semiconductor integrated circuit (LSI), and controls and drives the drain drivers 130 and the gate drivers 140 on the basis of display control signals such as a clock signal CK, a display timing signal DTMG, a horizontal synchronizing signal HSYNC and a vertical synchronizing signal VSYNC as well as display data (R, G and B) all of which are transmitted from a host computer.

When the display timing signl DTMG is inputted to the display control device 110, the display control device 110 determines that a display start position has been received, and outputs a single line of received display data to the drain drivers 130 via a bus line 133 for display data.

At this time, the display control device 110 outputs, via signal lines, display data latching clock signals CL2A and CL2B each of which is a display control signal for latching display data into the data latch circuit of each of the drain drivers 130.

These display data latching clock signals (hereinafter referred to simply as the clock signals) CL2A and CL2B and the like will be described later.

The display data from the host computer is transmitted as 6- or 8-bit data in units of one pixel, i.e., as one set of red (R), green (G) and blue (B) data at intervals of a unit time period.

When the input of the display timing signal is completed or a predetermined time period passes after the display timing signal has been inputted, the display control device 110 determines that one horizontal line of display data has reached its end, and outputs, to each of the drain drivers 130 via a signal line, an output timing control clock CL1 which is a display control signal for outputting the display data stored in the data latch circuits of the respective drain drivers 130 to the corresponding drain signal lines D of the liquid crystal display panel 10.

In addition, when the first display timing signal is inputted to the display control device 110 after the input of a vertical synchronizing signal, the display control device 110 determines that the first numbered display line has been received, and outputs a frame start indication signal FLM to the corresponding one of the gate drivers 140 via a signal line.

Moreover, the display control device 110 outputs a shift clock signal CL3 having a cycle of one horizontal scanning time, to the gate drivers 140 via a signal line so that a positive bias voltage is sequentially applied to each of the gate signal lines G of the liquid crystal display panel 10 at intervals of one horizontal scanning time on the basis of a horizontal synchronizing signal.

In this manner, a plurality of thin film transistors TFT1 and TFT2 connected to each of the gate signal lines G of the liquid crystal display panel 10 are turned on for one horizontal synchronizing time.

By the above-described operation, an image is displayed on the liquid crystal display panel 10.

The power source circuit 120 shown in FIG. 1 is made of a positive voltage generation circuit 121, a negative voltage generation circuit 122, a common electrode (counter electrode) voltage generation circuit 123 and a gate electrode voltage generation circuit 124.

Each of the positive voltage generation circuit 121 and the negative voltage generation circuit 122 is made of a series resistance voltage dividing circuit, and the positive voltage generation circuit 121 outputs a five-level gray scale reference voltage (V″0 to V″4) of positive polarity, while the negative voltage generation circuit 122 outputs a five-level gray scale reference voltage (V″5 to V″9) of negative polarity.

The gray scale reference voltage (V″0 to V″4) of positive polarity and the gray scale reference voltage (V″5 to V″9) of negative polarity are supplied to each of the drain drivers 130.

In addition, an alternation signal (alternation timing signal; M) from the display control device 110 is supplied to each of the drain drivers 130.

The common electrode voltage generation circuit 123 generates a driving voltage to be applied to the common electrode ITO2, while the gate electrode voltage generation circuit 124 generates driving voltages (a positive bias voltage and a negative bias voltage) to be applied to the gate electrodes of the thin film transistors TFT1 and TFT2.

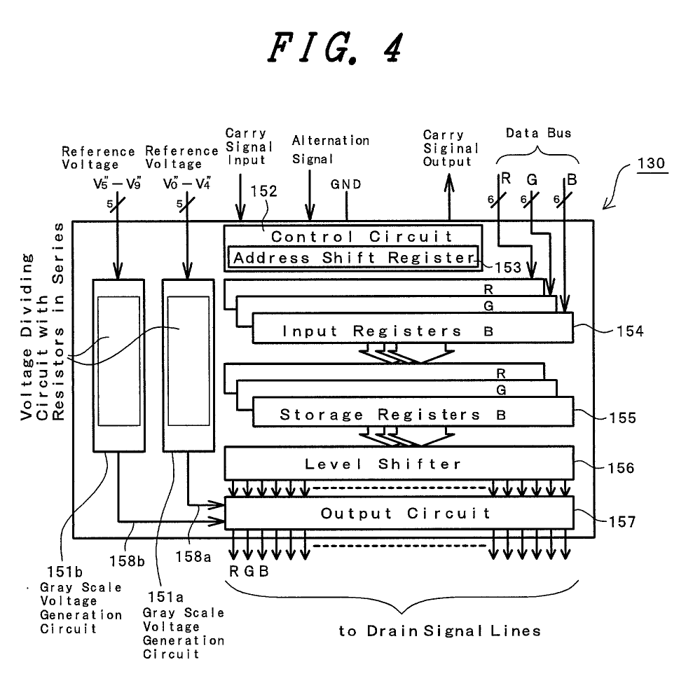

FIG. 4 is a block diagram showing the schematic construction of one example of the drain drivers 130 shown in FIG. 1.

Incidentally, the drain driver 130 is made of one semiconductor integrated circuit (LSI).

In FIG. 4, letting n be the number of bits of a display datum, a positive gray scale voltages generation circuit 151a generates a 2ⁿ-level gray scale voltage of positive polarity on the basis of the five-level gray scale reference voltage (V″0 to V″4) of positive polarity inputted from the positive voltage generation circuit 121, and outputs the 2ⁿ-level gray scale voltage to an output circuit 157 via a voltage bus line 158a.

A negative gray scale voltages generation circuit 151b generates a 2ⁿ-level gray scale voltage of negative polarity on the basis of the five-level gray scale reference voltage (V″5 to V″9) of negative polarity inputted from the negative voltage generation circuit 122, and outputs the 2ⁿ-level gray scale voltage to the output circuit 157 via a voltage bus line 158b.

A shift register circuit 153 in a control circuit 152 of the drain driver 130 generates a data acquisition signal for an input register circuit 154 and outputs the data acquisition signal to the input register circuit 154, on the basis of the clock signal CL2A (or the clock signal CL2B) inputted from the display control device 110.

The input register circuit 154 latches display data of n bits for each color by the number of output terminals in synchronism with the clock signal CL2A (or the clock signal CL2B) inputted from the display control device 110, on the basis of the data acquisition signal outputted from the shift register circuit 153.

A storage register circuit 155 latches the display data stored in the input register circuit 154, in response to the output timing control clock signal CL1 inputted from the display control device 110.

The display data acquired into the storage register circuit 155 is inputted to the output circuit 157 via a level shift circuit 156.

The output circuit 157 selects one gray scale voltage corresponding to the display data from the 2ⁿ-level gray scale voltage of positive polarity or the 2ⁿ-level gray scale voltage of negative polarity, and outputs the selected gray scale voltage to each of the drain signal lines D.

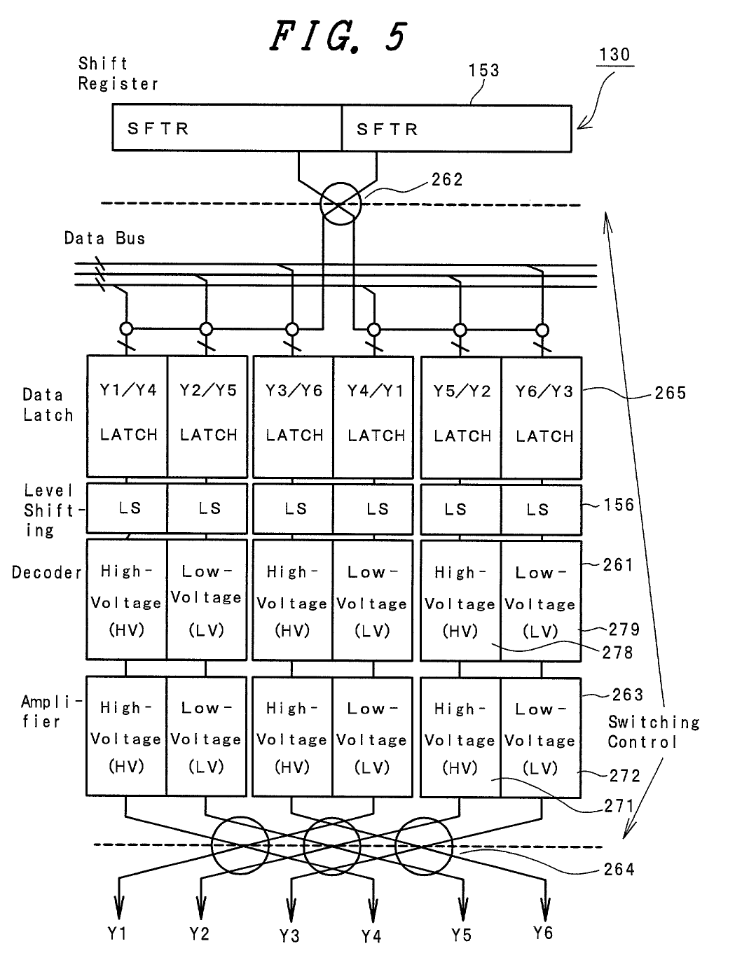

FIG. 5 is a block diagram for explaining the construction of the drain driver 130 shown in FIG. 4, as well as the construction of the output circuit 157.

In general, if the same voltage (DC voltage) is applied to a liquid crystal layer for a long time, the inclination of the liquid crystal layer is fixed, so that an image-retention phenomenon is caused to reduce the life of the liquid crystal layer.

To prevent this problem, in the related art TFT type of liquid crystal display module, AC diving voltage is applied to the liquid crystal layer.

As a driving method of applying AC voltage to the liquid crystal layer, a common symmetry driving method such as a dot inversion method (inverting voltage bias applied to liquid crystals per dot) or an N-lines inversion method (inverting voltage bias applied to liquid crystals per N-lines) are known, and FIG. 5 shows a construction in which the dot inversion method is adopted as a driving method.

In FIG. 5, reference numeral 153 denotes the shift register circuit included in the control circuit 152, and reference numeral 156 denotes the level shift circuit shown in FIG. 4. Data latch parts 265 represent the input register circuit 154 and the storage register circuit 155 that are shown in FIG. 4. In addition, decoder parts (gray scale voltage selection circuits) 261, amplifier circuit pairs 263, and switching parts (2) 264 for switching the outputs of the amplifier circuit pairs 263 constitute the output circuit 157 shown in FIG. 4.

In this construction, a switching part (1) 262 and the switching parts (2) 264 are controlled on the basis of the alternation signal M.

Symbols Y1, Y2, Y3, Y4, Y5 and Y6 denote, respectively, the first, second, third, fourth, fifth and sixth drain signal lines D.

In the drain driver 130 shown in FIG. 5, the switching part (1) 262 switches data acquiring signals to be inputted to the data latch parts 265 (more specifically, the input register circuit 154 shown in FIG. 4), thereby inputting display data for each color to the corresponding pair of adjacent ones of the data latch parts 265 for each color.

Each of the decoder parts 261 is made of a high voltage decoder circuit 278 and a low voltage decoder circuit 279. The high voltage decoder circuit 278 selects a gray scale voltage of positive polarity corresponding to the display data outputted from the corresponding one of the data latch parts 265 (more specifically, the storage register circuit 155 shown in FIG. 4), from the 2ⁿ-level gray scale voltage of positive polarity outputted from the positive gray scale voltage generation circuit 151a via the voltage bus line 158a, whereas the low voltage decoder circuit 279 selects a gray scale voltage of negative polarity corresponding to the display data outputted from the corresponding one of the data latch parts 265, from the 2ⁿ-level gray scale voltage of negative polarity outputted from the negative gray scale voltage generation circuit 151b via the voltage bus line 158b.

The high voltage decoder circuit 278 and the low voltage decoder circuit 279 are respectively provided in the adjacent ones of the data latch parts 265.

Each of the amplifier circuit pairs 263 is made of a high voltage amplifier circuit 271 and a low voltage amplifier circuit 272.

The gray scale voltage of positive polarity selected by the corresponding one of the high voltage decoder circuits 278 is inputted to the high voltage amplifier circuit 271, and the high voltage amplifier circuit 271 outputs a gray scale voltage of positive polarity.

The gray scale voltage level of negative polarity selected by the corresponding one of the low voltage decoder circuit 279 is inputted to the low voltage amplifier circuit 272, and the low voltage amplifier circuit 272 outputs a gray scale voltage of negative polarity.

In the dot inversion method, the gray scale voltage for each color is of opposite polarity to the gray scale voltage for the adjacent color, and the arrangement of the high voltage decoder circuits 271 and the low voltage decoder circuits 272 of the amplifier circuit pairs 263 is in the order of the high voltage amplifier circuit 271→the low voltage amplifier circuit 272→the high voltage amplifier circuit 271→the low voltage amplifier circuit 272. Data acquiring signals to be inputted to the data latch parts 265 are switched by the switching part (1) 262, thereby inputting display data for each color to the corresponding pair of adjacent ones of the data latch parts 265 for each color, and according to this input operation, the output voltages from the high voltage amplifier circuits 271 or the low voltage amplifier circuits 272 are switched by the switching parts (2) 264 and are outputted to the drain signal lines D to which to output gray scale voltages for the respective colors, for example, to the first drain signal line Y1 and the fourth drain signal line Y4. In this manner, a gray scale voltage of positive polarity or negative polarity can be outputted to each of the drain signal lines D.

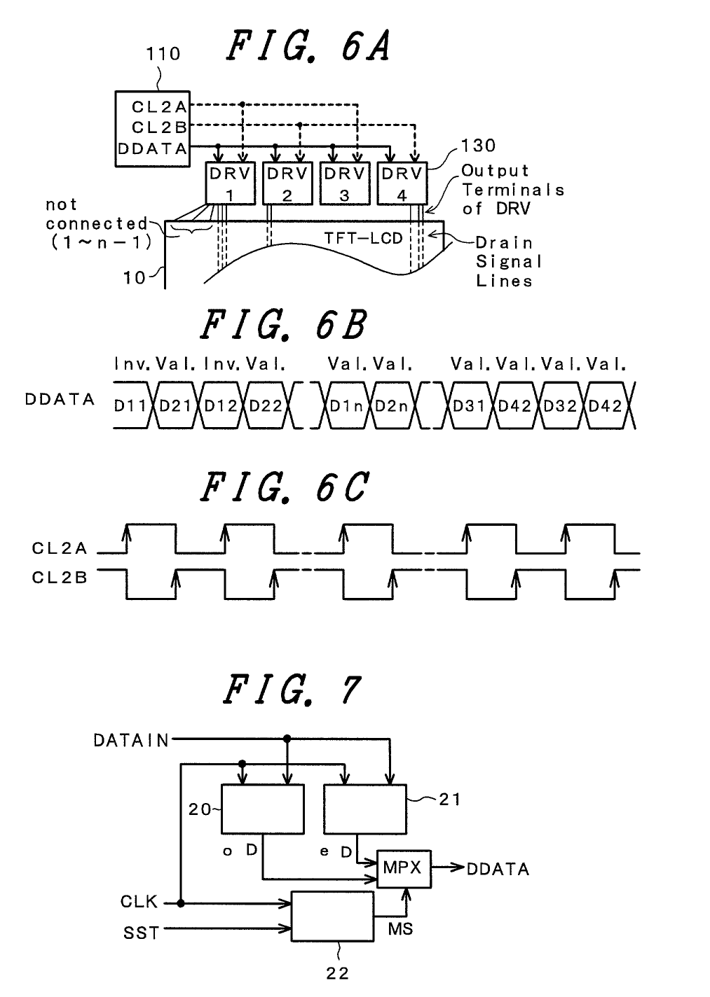

FIG. 6A is a block diagram showing transmission paths of display data from the display control device 110 to the liquid crystal display panel 10 shown in FIG. 1, FIG. 6B is an eye-diagram explaining the arrangement of the display data outputted from the display control device, and FIG. 6C is waveform diagrams explaining the phase relationship between the clock signals CL2A and CL2B.

As shown in FIG. 6C, the clock signal CL2B is the inverted signal of the clock signal CL2A, and the clock signal CL2A is inputted to odd-numbered drain drivers DRV1 and DRV3, while the clock signal CL2B is inputted to even-numbered drain drivers DRV2 and DRV4.

Accordingly, the display control device 110 alternately transmits display data for an even-numbered drain driver and display data for an odd-numbered drain driver to the bus line 133 in the order of display data for an even-numbered drain driver→display data for an odd-numbered drain driver→display data for an even-numbered drain driver→display data for an odd-numbered drain driver . . . .

FIG. 7 is a view showing the construction of a display data transmission part in the display control device 110 shown in FIG. 1.

If display data DATAIN are inputted to the display control device 110 from the outside, display data for the odd-numbered drain drivers are inputted to an odd-number memory 20, while display data for the even-numbered drain drivers are inputted to an even-number memory 21.

Then, these written display data are sequentially read out from a starting address in synchronism with a read-out clock signal CLK after the application of a read-out start signal.

Read-out display data o/D and e/D are inputted to a multiplexer MPX, and either of the display data o/D or e/D is selected in accordance with a selection signal (MS) from a selector generator part 22 and is transmitted to the bus line 133 as display data DDATA.

In the case of a single-path transmission system like that of Embodiment 1, the multiplexer MPX and the display data o/D and e/D are alternately selected.

At this time, the selector generator part 22 generates the selection signal MS with reference to a start pulse SST in synchronism with the read-out clock signal CLK.

In the above-described liquid crystal display device, there is a case where general drain drivers are used as the drain drivers 130 for the purpose of cost reduction. In this case, there is a case where the number of drain signal lines of the liquid crystal display panel is smaller than the number of output terminals of all the drain drivers (in other words, each of the drain drivers has an excess output terminal which does not correspond to any of the drain signal lines of the liquid crystal display panel). In such a case, the drain drivers have conventionally been used in such a manner that the drain signal lines D of the liquid crystal display panel are not connected to the excess output terminals of the drain drivers.

One example of the manner in which such drain drivers are used is shown in FIGS. 6A-6C.

The example shown in FIG. 6A represents the case where a first drain driver DRV1 has 1 to (n−1) output terminals which are not connected to the drain signal lines (hereinafter referred to simply as unconnected output terminals).

In the case of the example shown in FIG. 7, it is assumed that writing to the odd-number memory 20 is started at an address determined by adding (n−1) to its starting address, while writing to the even-number memory 21 is started at the starting address thereof.

In this manner, when the written data are sequentially read out from the starting addresses, an effective datum (Val.) is outputted from D1n and the display data DDATA shown in FIG. 6B are obtained.

However, the input register circuit 154 and the storage register circuit 155 shown in FIG. 4 need to latch data by an amount equivalent to the number of the output terminals of the drain drivers.

To this end, as described previously, an H level or an L level is outputted to each of the unconnected output terminals of the drain drivers as an ineffective display datum.

In the example shown in FIG. 6B, for instance, if an H level is transmitted as an ineffective display datum (Inv.) for the unconnected output terminal of the drain driver DRV1 and effective display data (Val.) for the 1 to (n−1) output terminals of the drain driver DRV2 are L levels, there is a case where the data on the bus line 133 change in the follow manner: H level (an ineffective display datum (Inv.) for the drain driver DRV1)→L level (an effective display datum (Val.) for the drain driver DRV2)→H level (an ineffective display datum (Inv.) for the drain driver DRV1), so that the transmission frequency on the bus line 133 increases.

A transmission method for ineffective display data according to the invention will be described below.

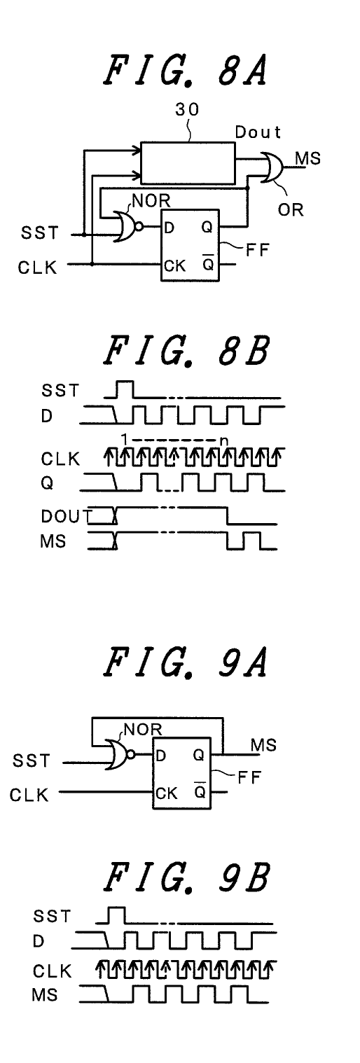

FIG. 8A is a block diagram showing the circuit construction of the selector generator part 22 shown in FIG. 7, and FIG. 8B is a diagram showing waveforms of input signals to the selector generator part 22 and output signals therefrom.

As shown in FIG. 8A, the selector generator part 22 is made of a D-type flip-flop FF, a counter CK decoder part 30, a NOR circuit NOR and an OR circuit OR.

The counter CK decoder part 30 has a counter which counts the clock number of the read-out clock signal CLK, and a decoder which decodes the count number of the counter.

FIGS. 9A and 9B are a block diagram showing a circuit construction of the selector generator part 22 in which the counter CK decoder part is omitted from the circuit construction shown in FIGS. 8A, and FIG. 9B is a diagram showing waveforms of input signals to the selector generator part 22 of FIG. 9A and output signals.

In the circuit construction shown in FIG. 9A, when the start pulse SST goes to its H level, the NOR circuit NOR goes to its L level as FIG. 9B shows. Therefore, if the read-out clock signal CLK is applied to the D-type flip-flop FF when the start pulse SST is at the H level, the D-type flip-flop FF is reset, and an output terminal Q goes to its L level and the selection signal MS goes to its L level.

Then, when the start pulse SST goes to its L level, the output of the NOR circuit NOR goes to the L level when the output terminal Q of the D-type flip-flop FF is at its H level, or goes to the H level when the output terminal Q of the D-type flip-flop FF is at the L level. Therefore, the selection signal MS repeats its H level and its L level in synchronism with the read-out clock signal CLK.

If the multiplexer MPX is set to select the odd-number memory 20 when the selection signal MS is at the L level, or the even-number memory 21 when the selection signal MS is at the H level, when the selection signal MS changes in the order of L level, H level, L level . . . , an odd-numbered datum, an even-numbered datum, an odd-numbered datum . . . are transmitted from the multiplexer MPX to the bus line 133.

The circuit construction shown in FIG. 8A is the same in basic operation as the circuit shown in FIG. 9A.

However, the circuit construction shown in FIG. 8A is set so that if the clock number of the read-out clock signal CLK is not greater than a set number, an output Dout of the counter CK decoder part 30 goes its H level, while if the clock number of the read-out clock signal CLK exceeds the set number, the output Dout of the counter CK decoder part 30 goes to its L level.

As FIG. 8B shows, by setting the decode number of the counter CK decoder part 30 (condition to output a decoding command signal) to the number of unconnected output terminals (n−1), after the start pulse SST is inputted to the counter CK decoder part 30, while (n−1) read-out clock signals CLK are inputted, the output Dout maintains its H level, and the selection signal MS is fixed at the H level.

If the clock number exceeds the set number (the number of unconnected output terminals (n−1)), the output Dout of the counter CK decoder part 30 goes to the L level in synchronism with the read-out clock signal CLK, and the output from the output terminal Q of the D-type flip-flop FF is outputted as the selection signal MS.

In this manner, in Embodiment 1, the selection signal MS is generated to select the even-number memory 21 whenever ineffective display data for the unconnected portions are to be transmitted.

Accordingly, in Embodiment 1, an effective display datum D21 to be transmitted to the drain driver DRV2 is transmitted as a datum for the ineffective display datum D11, and similarly, an effective display datum D22 is transmitted as the ineffective display datum D12.

That is to say, in Embodiment 1, display data are transmitted in the order of D21, D21, D22, D22, D23, D23 . . . , and from the effective display datum D1n, display data are transmitted in the order of D1n, D2n, D1(n +1) . . .

Accordingly, in Embodiment 1, as in the case of the previously-described prior art example, during transmission of display data containing ineffective display data, it is possible to reduce the transmission frequency on the bus line, whereby it is possible to reduce the amount of generation of radiant electromagnetic noise.

Incidentally, in the above description, reference has been made to the case where the first drain driver DRV1 has unconnected output terminals, but even in other cases where the last drain driver has unconnected output terminals or the number of even-numbered drain drivers and the number of odd-numbered drain drivers differ from each other, it is possible to provide a solution by using a similar construction.

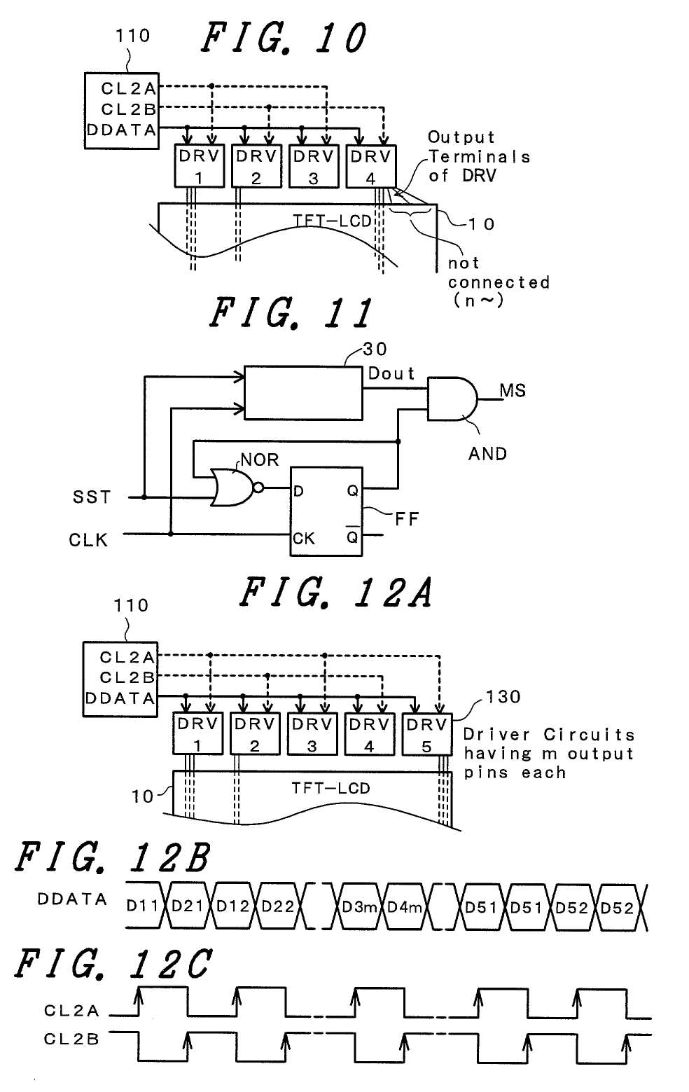

For example, as shown in FIG. 10, in the case where the last drain driver DRV4 has unconnected output terminals, the circuit construction is adopted as the selector generator part 22 shown in FIG. 7, whereby it is possible to obtain an advantage similar to that of the above-described embodiment.

In the circuit construction shown in FIG. 11, an AND circuit AND is adopted instead of the OR circuit OR shown in FIGS. 8A and 8B, and the count number of the read-out clock signal CLK is set to (n−1).

In this construction, the selection signal MS is generated so that the odd-number memory 20 and the even-number memory 21 are alternately selected until the count number of the read-out clock signal CLK reaches (n−1), and if the counter number of the read-out clock signal CLK exceeds n, the selection signal MS is generated so that the output of the odd-number memory 20 is normally selected.

In this manner, data to be transmitted to unconnected output terminal portions (ineffective display data) become the same display data as those of the drain driver DRV3.

Otherwise, as shown in FIG. 12A, even in the case where the number of the odd-numbered drain drivers DRV1, DRV3 and DRV5 differs from the number of the even-numbered drain drivers DRV2 and DRV4, the circuit construction shown in FIG. 11 is adopted as the selector generator part 22 shown in FIG. 7, whereby it is possible to obtain an advantage similar to that of the above-described embodiment. Additionally, FIG. 12B is an eye-diagram explaining the arrangement of the display data outputted from the display control device 110 of FIG. 12A, and FIG. 12C is waveform diagrams explaining the phase relationship between the clock signals CL2A and CL2B.

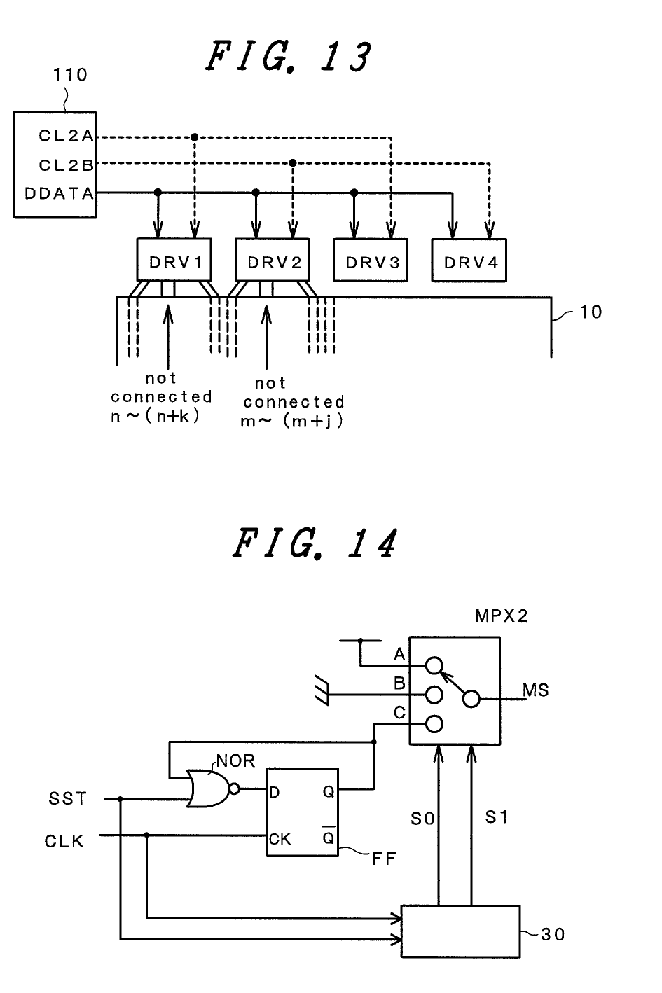

Moreover, as shown in FIG. 13, even in the case where each of the drain drivers DRV1 and DRV2 have unconnected output terminals and the positions of the unconnected output terminals are arbitrary positions such as a central portion, the circuit construction shown in FIG. 14 is adopted as the selector generator part 22 shown in FIG. 7, whereby it is possible to obtain an advantage similar to that of the above-described embodiment.

In the circuit shown in FIG. 14, a multiplexer MPX2 is switched by control signals S0 and S1 from the counter CK decoder part 30 so that a signal to be inputted to an input terminal A, a signal to be inputted to an input terminal B or a signal to be inputted to an input terminal C is selected as the selection signal MS.

In other words, the circuit shown in FIG. 14 is constructed to select the H level, the L level or the output level of the output terminal Q of the D-type flip-flop FF in accordance with the result of decoding by the counter CK decoder part 30.

In this construction, the counter CK decoder part 30 is set so that it can decode the unconnected output terminals of the drain driver DRV1 (n to (n+k) in FIG. 13; e.g. the tenth to fifteenth output terminals) as well as the unconnected output terminals of the drain driver DRV1 (m to (m+j) in FIG. 13; e.g. the twentieth to fiftieth output terminals). The respective output terminals of the drain drivers DRV1-DRV4 in FIG. 13 are numbered from one end of the liquid crystal display panel 10 (left side thereof, in this example) or from one of the output terminals closest to the display control device 110, but numbering the output terminals should not limited to such manners as mentioned in this embodiment.

One example of the selection signal MS to be selected by the multiplexer MPX2 in accordance with the control signals S0 and S1 from the counter CK decoder part 30 is shown in Table 1.

TABLE 1

| S1 | S0 | MS |
|---|---|---|
| L | L | C |
| L | H | A |
| H | L | B |
| H | H | B |

In the above description, data for the output terminals of a drain driver are controlled by the selection signal MS, but instead the method of writing data to the memories may be altered.

For instance, in the case where the drain driver DRV1 shown in FIGS. 6A and 6B has (n−1) unconnected output terminals, data having the same contents as data to be written to the first to (n−1)th addresses of the odd-number memory 20 are written to the first to (n−1)th addresses of the even-number memory 21.

With this construction, it is possible to use the circuit construction shown in the FIGS. 9A and 9B as the selector generator part 22 which generates the selection signal MS.

### Embodiment 2

In FIG. 1, regarding the display data R, G and B to be inputted from the outside such as the host computer, there are two ways in which to input the display data. One way is to input the display data in units of one pixel, and the other way is to input the display data in units of two pixels in order to cope with increases in the resolution and operation of the liquid crystal display panel 10.

In a prior art, different display control devices have been used according to the two ways, i.e., the case where the display data are inputted in units of one pixel and the case where the display data are inputted in units of two pixels.

For this reason, the prior art has the disadvantage that the cost of the liquid crystal display device increases.

Embodiment 2 intends to provide a display control device 110 which can cope with these two kinds of display data inputting methods and is constructed to switch its input mode in the inside or according to a voltage to be inputted to a mode pin.

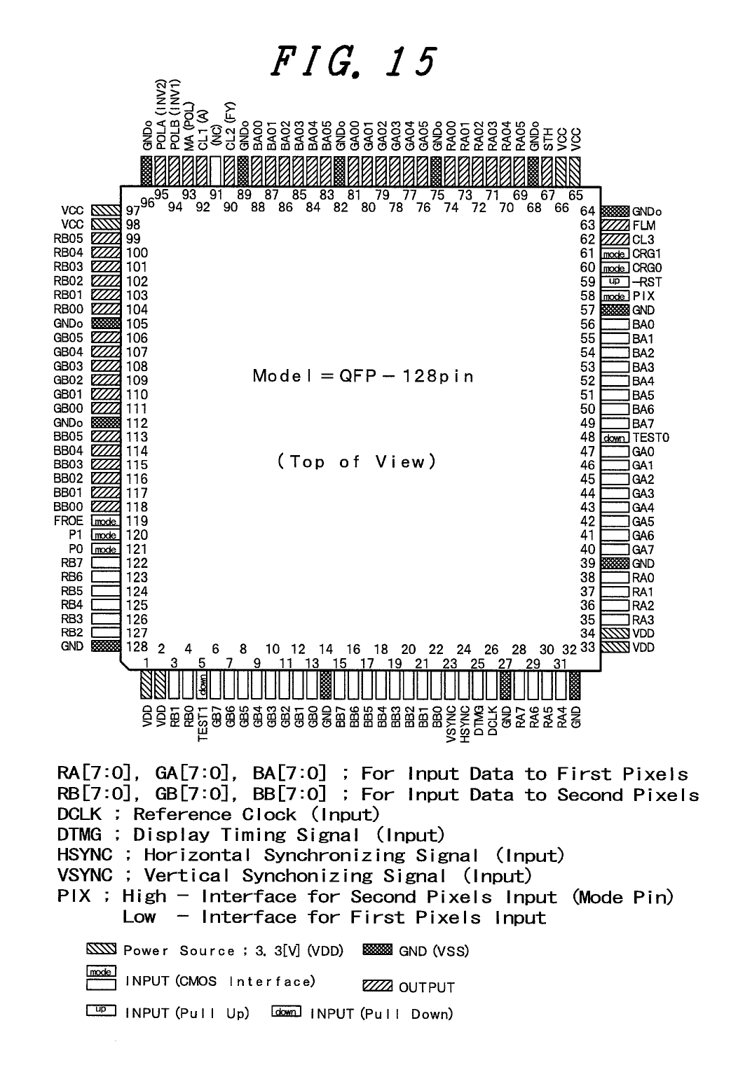

FIG. 15 is a view showing the arrangement of the pins of a display control device (Large Scale Integrated circuit: LSI) according to Embodiment 2 of the invention.

As described above, the display control device 110 of Embodiment 2 can cope with an interface for inputting data in units of one pixel or two pixels, and the setting of the display control device 110 is performed with a voltage to be applied to a mode pin PIX.

In Embodiment 2, in the case of one-pixel input specifications, the voltage to be applied to the mode pin PIX is fixed at an L level, whereas in the case of two-pixel input specifications, the voltage to be applied to the mode pin PIX is fixed at an H level.

The following description will be given in connection with a setting method for one-pixel input specifications and a setting method for two-pixel input specifications in the display control device 110 of Embodiment 2.

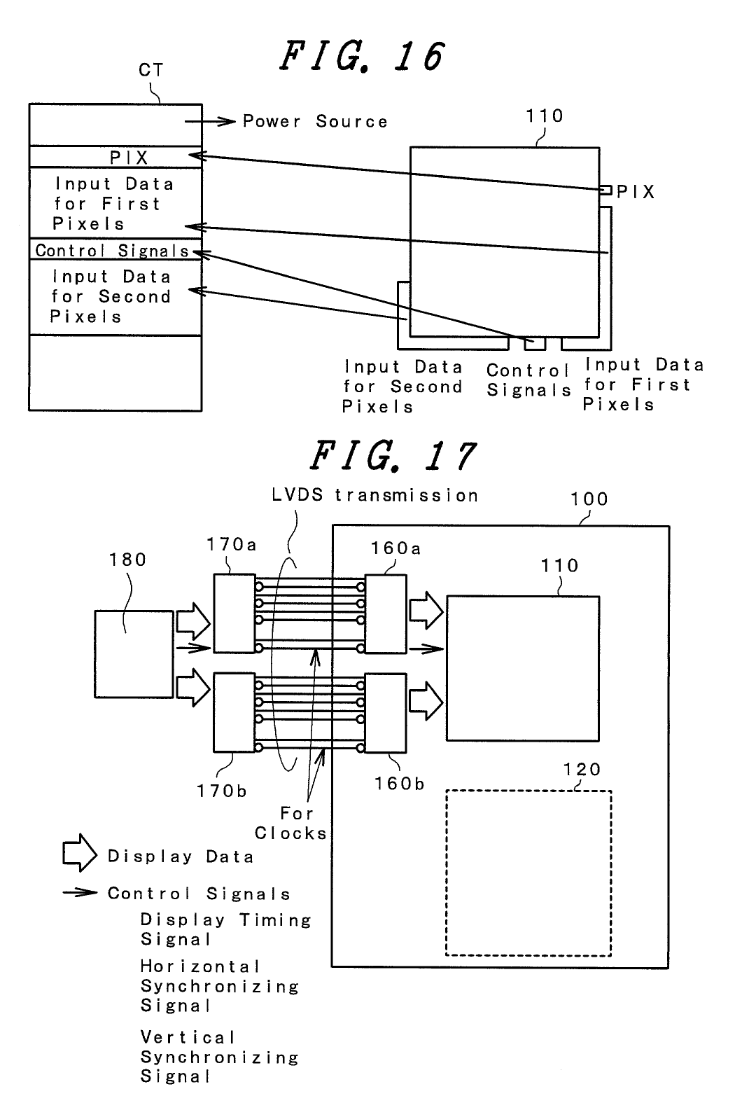

FIG. 16 is a view for explaining a method of setting the mode pin PIX in the case where each input terminal of the display control device 110 is directly connected to an interface connector CT.

In this case, input terminals for display data for the first pixels, display data for the second pixels and control signals as well as the mode pin PIX are directly connected to an interface connector CT.

Accordingly, in this example, the voltage to be applied to the mode pin PIX is set from an outside such as a host computer, thereby setting the one-pixel input specifications or the two-pixel input specifications.

In recent years, instead of analog interfaces, digital interfaces have been adopted as interfaces between liquid crystal display modules and host computers.

As these digital interfaces, two methods are known, the LVDS (Low Voltage Differential Signaling) method and the Panel Link method.

FIG. 17 is a block diagram showing the construction of the essential portions of an TFT type of liquid crystal display module in which the LVDS method is adopted as its digital interface.

As shown in FIG. 17, transmitters 170a and 170b and receivers 160a and 160b each made of a semiconductor integrated circuit LSI are provided between the output end of a graphic controller 180 of the host computer and the input end of the display control device 110.

The circuit construction of the other portions is the same as the circuit construction of those shown in FIG. 1, and the illustration thereof is omitted.

The transmitter 170a (or 170b) performs parallel-series conversion on a 12-bit signal which contains the display timing signal DTMG, the horizontal synchronizing signal HSYNC, the vertical synchronizing signal VSYNC and the display data R, G and B, and transmits the obtained serial signal to the receiver 160a (or 160b) through three stranded paired wires.

The receiver 160a (or 160b) performs series-parallel conversion on the serial signal and transmits the display timing signal DTMG, the horizontal synchronizing signal HSYNC, the vertical synchronizing signal VSYNC and the display data R, G and B.

A clock signal CK is transmitted from the transmitter 170a (or 170b) to the receiver 160a (or 160b) through one stranded paired wire.

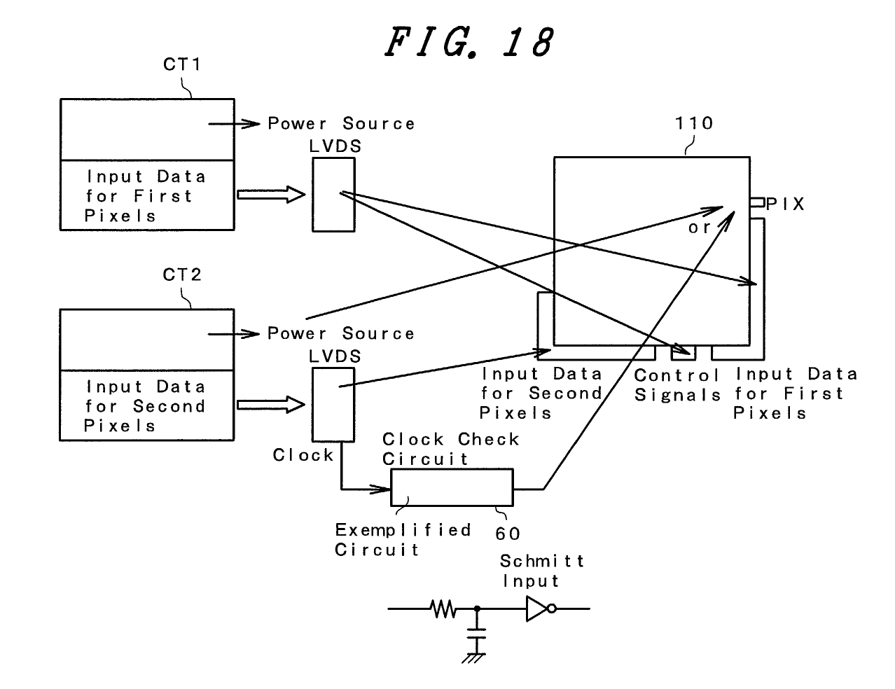

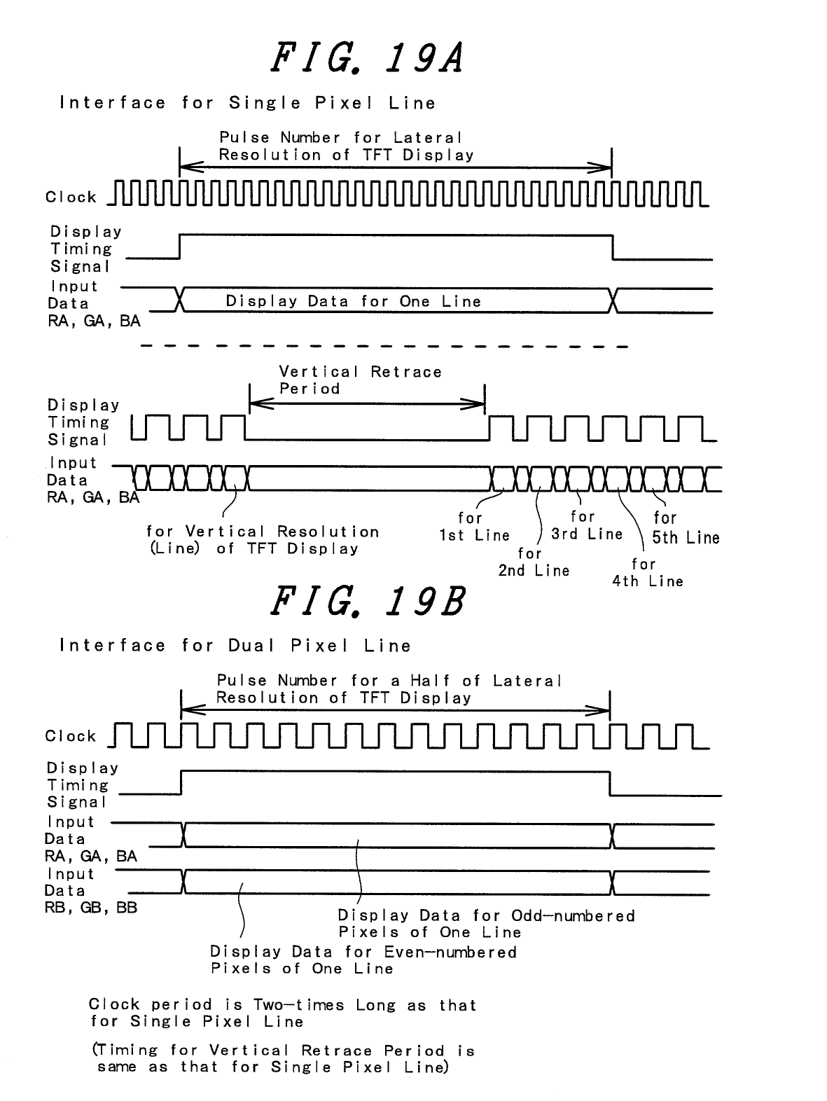

FIG. 18 is a view for explaining a method of setting the mode pin PIX in the case where display data and the like are inputted to the display control device 110 from the outside by the LVDS method.

In this case, the display control device 110 has a connector CT1 for display data for the first pixels and a connector CT2 for input display data for the second pixels.

Whether input display data for the second pixels are present is determined by confirming whether a voltage is produced at the connector CT2 to which the input display data for the second pixels should be transmitted, or whether a receiver which should transmit the input display data for the second pixels has outputted the clock signal CK, and the result is reflected at the mode pin PIX of the display control device 110.

Whether the clock signal CK has been outputted from the receiver which should transmit the input display data for the second pixels can be determined by providing a clock check circuit 60 as shown in FIG. 18 by way of example.

Specifically, whether the clock signal CK has been outputted is detected by a low-pass filter made of a resistor R and a capacitor C, and the voltage at the mode pin PIX is set according to the output voltage from the low-pass filter.

The above-described method is a method of switching the input modes according to voltages to be applied to the mode pin PIX of the display control device 110, and this switching can also be performed in the inside of the display control device 110.

As shown in FIG. 19A, the display timing signal inputted from the outside indicates a display data interval within one line (a period of H-level in FIG. 19A). Accordingly, in the case of the one-pixel input operation mode, the clock number of the clock signal CK in the display timing signal coincides with the number of pixels of the liquid crystal display panel 10 in the horizontal direction thereof.

In the case of the two-pixel input operation mode, the clock number of the clock signal CK in the display timing signal becomes half of the lateral number of pixels of the liquid crystal display panel 10, as FIG. 19B shows.

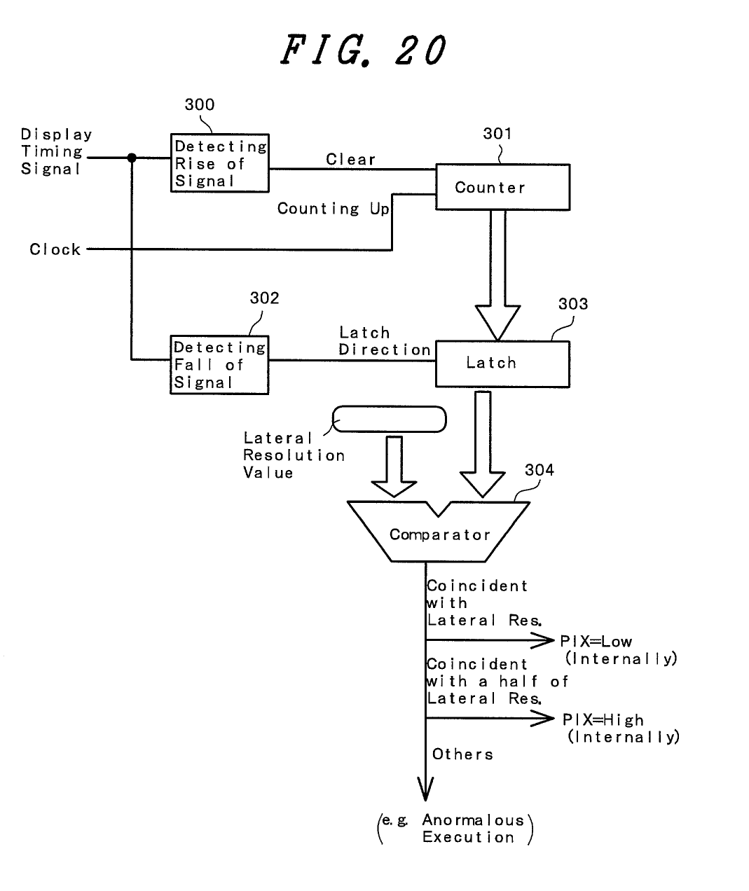

Therefore, if, in the side of the display control device 110, a circuit such as that shown in FIG. 20 is used to determine the clock number of the clock signal CK contained in the display timing signal, it is possible to determine whether the input mode is based on the one-pixel input specifications or the two-pixel input specifications.

In the circuit shown in FIG. 20, the rise detecting circuit 300 detects the time point of rise of the display timing signal and resets a counter circuit 301 at this time point of rise, and then counts the clock number of the clock signal CK.

In addition, a fall detecting circuit 302 detects the time point of fall of the display timing signal and latches the count number of the counter circuit 301 into a latch circuit 303.

The count number latched in the latch circuit 303 and the lateral number of pixels (i.e., lateral resolution) of the liquid crystal display panel 10 are compared with each other by a comparing circuit 304.

If the result of the comparison made by the comparing circuit 304 indicates that the clock number of the clock signal CK in the display timing signal coincides with the lateral number of pixels of the liquid crystal display panel 10, the one-pixel input specifications are specified as input mode in the inside of the display control device 110. On the other hand, if the result of the comparison made by the comparing circuit 304 indicates that the clock number of the clock signal CK in the display timing signal coincides with half of the lateral number of pixels of the liquid crystal display panel 10, the two-pixel input specifications are specified as input mode in the inside of the display control device 110.

All cases other than those two cases are processed as anomalous execution.

In the case of the above-described example, since the mode pin PIX of the display control device 110 is not needed, the size of the display control device 110 can be effectively reduced.

In the description of each of the above-described embodiments, reference has been made to the case where the invention is applied to a vertical electric field type of liquid crystal display panel, but the invention is not limited to this case, and can also be applied to an in-plane switching mode of liquid crystal display panel.

In the description of each of the above-described embodiments, reference has also been made to the case where the invention is applied to a TFT type of liquid crystal display device, but the invention is not limited to this case, and it goes without saying that the invention can also be applied to an STN type of simple matrix liquid crystal display device.

While the invention made by the present inventor has been specifically described on the basis of the embodiments of the invention, the invention is not limited to any of the above-described embodiments, and various changes and modifications can, of course, be made without departing from the gist of the invention.

The advantages of a representative aspect of the invention disclosed in the present application are summarized as follows:

(1) According to the invention, it is possible to decrease the transmission frequence on a bus line while display data containing ineffective display data are being transmitted from the display control device to each driving circuit; and

(2) According to the invention, a common display control device can be used in each input mode, whereby it is possible to reduce the cost of the liquid crystal display panel.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. A liquid crystal display device comprising:
a liquid crystal display element;
a plurality of driving circuits; and
a display control device transmitting display data including an ineffective datum to the plurality of driving circuits,
wherein the display control device transmits a datum having a same level as that of an effective display datum being transmitted prior to the ineffective display datum thereby instead of the ineffective display datum during a period when the ineffective display datum should be transmitted thereby.

2. A liquid crystal display device comprising:
a liquid crystal display element;
a plurality of driving circuits; and
a display control device transmitting display data including an ineffective datum to the plurality of driving circuits,
wherein the display control device transmits a datum having a same level as that of an effective display datum being transmitted subsequently to the ineffective display datum thereby instead of the ineffective display datum during a period when the ineffective display datum should be transmitted thereby.

3. A liquid crystal display device comprising:
a liquid crystal display element;
a plurality of driving circuits; and
a display control device transmitting display data for odd numbered ones of the plurality of driving circuits and display data for even numbered ones thereof alternately thereto,
wherein the display control device transmits a datum having a same level as that of an effective display datum for the odd numbered one of the plurality of driving circuits being transmitted prior to the ineffective display datum to be inputted to an at least one of the even numbered ones thereof instead of the ineffective display datum during a period when the ineffective display datum should be transmitted to the at least one of the even numbered ones thereof.

4. A liquid crystal display device comprising:
a liquid crystal display element;
a plurality of driving circuits; and
a display control device transmitting display data for odd numbered ones of the plurality of driving circuits and display data for even numbered ones thereof alternately thereto,
wherein the display control device transmits a datum having a same level as that of an effective display datum for the even numbered one of the plurality of driving circuits being transmitted subsequently to the ineffective display datum to be inputted to an at least one of the odd numbered ones thereof instead of the ineffective display datum during a period when the ineffective display datum should be transmitted to the at least one of the odd numbered ones thereof.

5. A liquid crystal display device according to claim 3, wherein
the at least one of the odd numbered ones of the plurality of driving circuits has an output terminal thereof being not connected to any signal lines of the liquid crystal display element, and
the ineffective display datum is a display datum for an internal circuit being connected to the output terminal.

6. A liquid crystal display device according to claim 4, wherein
the at least one of the even numbered ones of the plurality of driving circuits has an output terminal thereof being not connected to any signal lines of the liquid crystal display element, and
the ineffective display datum is a display datum for an internal circuit being connected to the output terminal.

7. A liquid crystal display device comprising:
a liquid crystal display element;
a plurality of driving circuits; and
a display control device transmitting display data inputted for odd numbered ones of the plurality of driving circuits and display data for even numbered ones thereof alternately thereto,
wherein the display control device has a first storing means for storing display data for the odd numbered ones of the plurality of driving circuits which are inputted from an outside of the liquid crystal display device and a second storing means for storing display data for the even numbered ones of the plurality of driving circuits which are inputted from an outside of the liquid crystal display device, reads out the display data from the first storing means and the second storing means alternately, and transmits them to the plurality of driving circuits, and
wherein the display control device transmits an effective display datum for the odd numbered thereof being transmitted prior to an ineffective display datum to be inputted to an at least one of the even numbered ones thereof instead of the ineffective display datum during a period when the ineffective display datum should be transmitted to the at least one of the even numbered ones thereof.

8. A liquid crystal display device according to claim 7, wherein the display control device detects timing for transmitting the ineffective display datum and transmits the effective display datum being read out from the first storing means as the ineffective display datum.

9. A liquid crystal display device according to claim 7, wherein the display control device stores the effective display datum for the odd numbered driving circuit being situated before the ineffective datum in the second storing means, when a display datum to be stored in the second storing means is ineffective.

10. A liquid crystal display device comprising:
a liquid crystal display element;
a plurality of driving circuits; and
a display control device transmitting display data for odd numbered ones of the plurality of driving circuits and display data for even numbered ones thereof alternately thereto,
wherein the display control device has a first storing means for storing display data for the odd numbered ones of the plurality of driving circuits which are inputted from an outside of the liquid crystal display device and a second storing means for storing display data for the even numbered ones of the plurality of driving circuits which are inputted from an/the outside of the liquid crystal display device, reads out the display data from the first storing means and the second storing means alternately, and transmits them to the plurality of driving circuits,
wherein the display control device transmits an effective display datum for the even numbered thereof being transmitted subsequently to an ineffective display datum to be inputted to an at least one of the odd numbered ones thereof instead of the ineffective display datum during a period when the ineffective display datum should be transmitted to the at least one of the odd numbered ones thereof.

11. A liquid crystal display device according to claim 9, wherein the display control device detects timing for transmitting the ineffective display datum and transmits the effective display datum being read out from the second storing means as the ineffective display datum.

12. A liquid crystal display device according to claim 10, wherein, the display control device stores the effective display datum for the even numbered driving circuit following the ineffective datum in the first storing means, when a display datum to be stored in the first storing means is ineffective.

13. A liquid crystal display device according to claim 8, wherein In the embodiments of the present invention, the display control device detects transmission timing of the ineffective datum by counting clock signals being transmitted to the plurality of the driving circuits.

14. A liquid crystal display device according to claim 7, wherein the at least one of the plurality of driving circuits has at least one output terminal being not connected to any signal lines of the liquid crystal display element, and the ineffective display datum is a display datum for an internal circuit being connected to the at least one output terminal.

15. A liquid crystal display device comprising:
a liquid crystal display element; and
a display control device controlling the liquid crystal display element, wherein the display control device changes an signal input mode thereof in accordance with a number of the display data in a display timing signals inputted thereto from an outside thereof.

16. A liquid crystal display device according to claim 15, wherein the display control device has counting means which counts external clock number in the display timing signal, discrimination means which discriminates an operation mode thereof in accordance with the count number counted by the counting means, and mode switching means for changing signal input mode thereof internally in accordance with discrimination result of the discrimination means.
